(19) United States
(12) Patent Application Publication
(10) Pub. No.: US 2013/0224453 A1
(43) Pub. Date: Aug. 29, 2013

(54) Spallation-Resistant Thermal Barrier Coating

(71) Applicants: Brian T. Hazel, Avon, CT (US); Benjamin J. Zimmerman, Enfield, CT (US); David A. Litton, West Hartford, CT (US)

(72) Inventors: Brian T. Hazel, Avon, CT (US); Benjamin J. Zimmerman, Enfield, CT (US); David A. Litton, West Hartford, CT (US)

(73) Assignee: UNITED TECHNOLOGIES CORPORATION, Hartford, CT (US)

(21) Appl. No.: 13/408,460

(22) Filed: Feb. 29, 2012

(51) Int. Cl. B32B 7/02; C23C 4/10; C23C 4/12

(52) U.S. Cl. 428/212; 427/446; 427/454

(57) ABSTRACT

In a method for coating a substrate, a ceramic first layer is suspension plasma sprayed and is at least about as tough as 7YSZ. A ceramic second layer is applied over the first layer and is less tough than the first layer.

### BACKGROUND

The disclosure relates gas turbine engines. More particularly, the disclosure relates to thermal barrier coatings for gas turbine engines.

Gas turbine engine gaspath components are exposed to extreme heat and thermal gradients during various phases of engine operation. Thermal-mechanical stresses and resulting fatigue contribute to component failure. Significant efforts are made to cool such components and provide thermal barrier coatings to improve durability.

Exemplary thermal barrier coating systems include two-layer thermal barrier coating systems. An exemplary system includes NiCoCrAlY bond coat (e.g., low pressure plasma sprayed (LPPS)) and an yttria-stabilized zirconia (YSZ) thermal barrier coat (TBC) (e.g., air plasma sprayed (APS) or electron beam physical vapor deposited (EBPVD)). Prior to and while the barrier coat layer is being deposited, a thermally grown oxide (TGO) layer (e.g., alumina) forms atop the bond coat layer. As time-at-temperature and the number of cycles increase, this TGO interface layer grows in thickness. U.S. Pat. No. 4,405,659 discloses an exemplary system. U.S. Pat. No. 7,326,470 discloses a two-layer ceramic system (YSZ base layer with gadolinium zirconate top layer). Gadolinium zirconate has low thermal conductivity but much lower toughness than YSZ. The lower (YSZ) layer facilitates the spallation resistance of the coating. The exemplary YSZ is 7 weight percent yttria-stabilized zirconia (7YSZ).

Exemplary TBCs are applied to thicknesses of 1-40 mils (0.025-1.0 mm) and can contribute to a temperature reduction of up to 300° F. at the base metal. This temperature reduction translates into improved part durability, higher turbine operating temperatures, and improved turbine efficiency.

### SUMMARY

One aspect of the disclosure involves a method for coating a substrate. A ceramic first layer is suspension plasma sprayed and is more at least about as tough as 7YSZ. A ceramic second layer is applied over the first layer and is less tough than the first layer.

In additional or alternative embodiments of any of the foregoing embodiments, the applying of the second ceramic layer may also be by suspension plasma spraying. In additional or alternative embodiments of any of the foregoing embodiments, a metallic bondcoat may be applied prior to the suspension plasma spraying of the first layer. In additional or alternative embodiments of any of the foregoing embodiments, the second layer may be applied directly atop the first layer. In additional or alternative embodiments of any of the foregoing embodiments, the coating may consist of or consists essentially of the first layer, the second layer, and any bondcoat, including transitions and TGO.

In additional or alternative embodiments of any of the foregoing embodiments, during said spraying of the first layer and said applying of the second layer, an environmental pressure may remain at least 95 kpa.

In additional or alternative embodiments of any of the foregoing embodiments: the first layer has a thickness of 0.013-0.076 mm; the second layer has a thickness of 0.025-0.48 mm; the first layer has a toughness of 40-90 J/m²; and the second layer has a toughness of 1-39 J/m².

In additional or alternative embodiments of any of the foregoing embodiments: the first layer has a toughness of 50-90 J/m2; and the second layer has a toughness of 2-20 J/m2.

In additional or alternative embodiments of any of the foregoing embodiments: the first layer has a thickness of 0.013-0.076 mm; the second layer has a thickness of 0.025-0.48 mm; the first layer has a coefficient of thermal conductivity of 1.4-1.7 W/mK; and the second layer has a coefficient of thermal conductivity of less than 1.1 W/mK.

In additional or alternative embodiments of any of the foregoing embodiments: the first layer has a coefficient of thermal conductivity of 1.4-1.7 W/mK; and the second layer has a coefficient of thermal conductivity of 0.4-0.9 W/mK.

In additional or alternative embodiments of any of the foregoing embodiments: the applying of the ceramic first layer is to a first layer depth of at least 0.013 mm; and the suspension plasma spraying of the ceramic second layer is to a second layer depth of at least 0.025 mm.

In additional or alternative embodiments of any of the foregoing embodiments, the first layer comprises zirconia-yttria-titania (e.g., titania-doped 7YSZ). In additional or alternative embodiments of any of the foregoing embodiments, the first layer comprises zirconia-titania-ceria. In additional or alternative embodiments of any of the foregoing embodiments, the first layer comprises zirconia-yttria-tantala.

In another aspect, a coated article may comprise: a substrate; a ceramic first layer having a toughness at least about as great as a toughness of 7YSZ and having a polycrystalline columnar microstructure; and a ceramic second layer above the first layer and being less tough than the first layer.

In additional or alternative embodiments of any of the foregoing embodiments: the first layer comprises material selected from the group consisting of zirconia-yttria-titania, zirconia-titania-ceria, and zirconia-yttria-tantala; and the second layer comprises gadolinia-stabilized zirconia.

In additional or alternative embodiments of any of the foregoing embodiments, the substrate may comprise a nickel-based superalloy.

In additional or alternative embodiments of any of the foregoing embodiments, a bondcoat may be between the first layer and the substrate.

In additional or alternative embodiments of any of the foregoing embodiments, the coated article may consist or consist essentially of the substrate, the bondcoat, the first layer, and the second layer.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic sectional view of substrate having a thermal barrier coating (TBC).

FIG. 2 is a partially schematic view of an apparatus for applying the thermal barrier coating to the substrate.

FIG. 3 is a flowchart of a process for coating the substrate of FIG. 1.

Like reference numbers and designations in the various drawings indicate like elements.

### DETAILED DESCRIPTION

FIG. 1 shows a thermal barrier coating system 20 atop a metallic substrate 22. In an exemplary embodiment, the substrate is a nickel-based superalloy or a cobalt-based superalloy such as a cast component (e.g., a single crystal casting) of a gas turbine engine. Exemplary components are hot section components such as combustor panels, turbine blades, turbine vanes, and airseals. One particular alloy is PWA-1484.

The coating system 20 may include a bondcoat 24 atop a surface 26 of the substrate 22 and a thermal barrier coating (TBC) system 28 atop the bondcoat. A thermally grown oxide (TGO) layer 30 may form at the interface of the bondcoat to the TBC.

The TBC is a multi-layer TBC with at least two layers. A first layer 40 is a lower layer and is relatively tough. A second layer 42 is over the first layer and is less tough than the first layer. In the exemplary system, the TBC consists of or consists essentially of the first and second layers (e.g., subject to relatively small gradation/transition with each other and with the bondcoat (if any) as noted above).

The exemplary bondcoat is a metallic bondcoat such as an overlay bondcoat or a diffusion aluminide. An exemplary MCrAlY overlay bondcoat is PWA-1386 NiCoCrAlYHfSi. This may be applied by low-pressure plasma spray (LPPS) among several possibilities. Alternative bondcoats are gamma/gamma prime and NiAlCrX bondcoats and may be applied via processes further including cathodic arc and ion plasma. Exemplary bondcoat thicknesses are 2-500 micrometers, more narrowly, 12-250 micrometers or 25-150 micrometers on average.

The exemplary first layer 40 has a fracture toughness at least about that of 7YSZ. One exemplary toughness test is: ASTM C1421-10 Standard Test Methods for Determination of Fracture Toughness of Advanced Ceramics at Ambient Temperature. Another test is for room temperature hardness testing of dense bodies as described in J. Am. Ceram. Soc., 90 [12] 3896-3901 (2007), the disclosure of which is incorporated by reference in its entirety herein as if set forth at length. 7YSZ toughness is measured as 39 J/m² therein (by which method toughness of other ceramic materials herein may also be measured). An exemplary first layer thickness is 0.001 inch (0.025 mm) with an exemplary range of 0.0005-0.003 inch (0.013-0.076 mm), more narrowly, 0.0007-0.002 inch (0.018-0.051 mm). Such exemplary layer thickness may be a local thickness or an average thickness (e.g., mean, median, or modal as may be thicknesses of the second layer discussed below).

Exemplary properties of the first layer and second layer may be measured in absolute terms or relative to properties of 7YSZ deposited under like conditions and measured under like conditions. An exemplary first layer material is pure 7YSZ or a slight variation (e.g., with minor amounts of dopants). Such exemplary first layer toughness is therefore about that of 7YSZ (e.g., 98-102% that of 7YSZ). However, particularly tougher alternative materials may be used. Thus, exemplary first layer toughness may be at least 98% that of 7YSZ, more narrowly, for the tougher materials, at least 115% (e.g., 102.5%-230% or 125%-230%). In absolute terms, exemplary first layer toughness is at least 38 J/m², more narrowly, at least 45 J/m² (e.g., 40-90 or 50-90 J/m²).

One group of examples for the first layer compositions are ZrO₂—YO_{1.5}—TiO₂ compositions. See, FIG. 1 in J. Am. Ceram. Soc., 90 [12] 3896-3901 (2007). These are compositions in the t′ phase field and most particularly where the t′+t phase field overlap.

Another group of examples for the first layer compositions are ZrO₂—TiO₂—CeO₂ compositions. Exemplary compositions are ZrO₂-10TiO₂-10CeO₂ (cation mole percent) and other compositions in the non-transformable phase field defined as ZrO2 richer than the T₀ (tetragonal-monoclinic transformation start) line.

Another group of examples for the first layer compositions are ZrO₂—YO_{1.5}—TaO_{2.5} compositions. See, non-transformable zone defined in FIG. 1 of Acta Materialia 58 4424-4431 (2010).

The second layer 42 has a facture toughness less than that of the first layer 40 and, more narrowly, less than that of 7YSZ. Exemplary second layer fracture toughness is less than that of the first layer and/or of 7YSZ (e.g., 1-39 J/m² more narrowly, 1-38 or 2-30 or 3-20 J/m²) or 2-98% of either or 5-98% of either or 5-77% of either or 8-50% of either, in absolute terms. The low toughness is not a goal in itself but a consequence of the material properties that also provide the desired low thermal conductivity. The exemplary second layer may also have a thermal conductivity lower than that of the first layer (e.g., less than 75%, more narrowly, 25%-75% or 30%-60%) and lower than that of 7YSZ. 7YSZ thermal conductivity is approximately 1.5 W/mK at room temperature as-deposited. See, Surface & Coatings Technology, 201[6] 2611-2620 (2006)), the disclosure of which is incorporated by reference in its entirety herein as if set forth at length.

The exemplary first layer is likely to have thermal conductivity similar to that of 7YSZ (e.g., 90-115% or 93-113% or 98-102% or 1.5 W/mK or 1.4-1.7 W/mK). Thus exemplary second layer thermal conductivity is less than 1.1 W/mK or an exemplary 0.4-0.9 W/mK

An exemplary thickness of the second layer is at least 0.001 inch (0.025 mm) (more particularly, 0.001-0.019 inch (0.025-0.48 mm) or 0.004-0.015 inch (0.1-0.038 mm). An exemplary total thickness of both ceramic layers is from 0.002-0.020 inch (0.05-0.5 mm) (more particularly, 0.005-0.016 inch (0.13-0.41 mm)).

Exemplary second layer compositions are cubic/fluorite/pyrochlore/delta phase fully stabilized zirconates where stabilizers are any oxide or mix of oxides including Lanthanide series, Y, Sc, Mg, Ca, or further modified with Ta, Nb, Ti, Hf. A particular composition is gadolina stabilized zirconia Gd₂Zr₂O₇ (See, J. Am. Ceram. Soc., 90 [2] 533-540 (2007)) or U.S. Pat. Nos. 6,117,560 and 6,177,200.

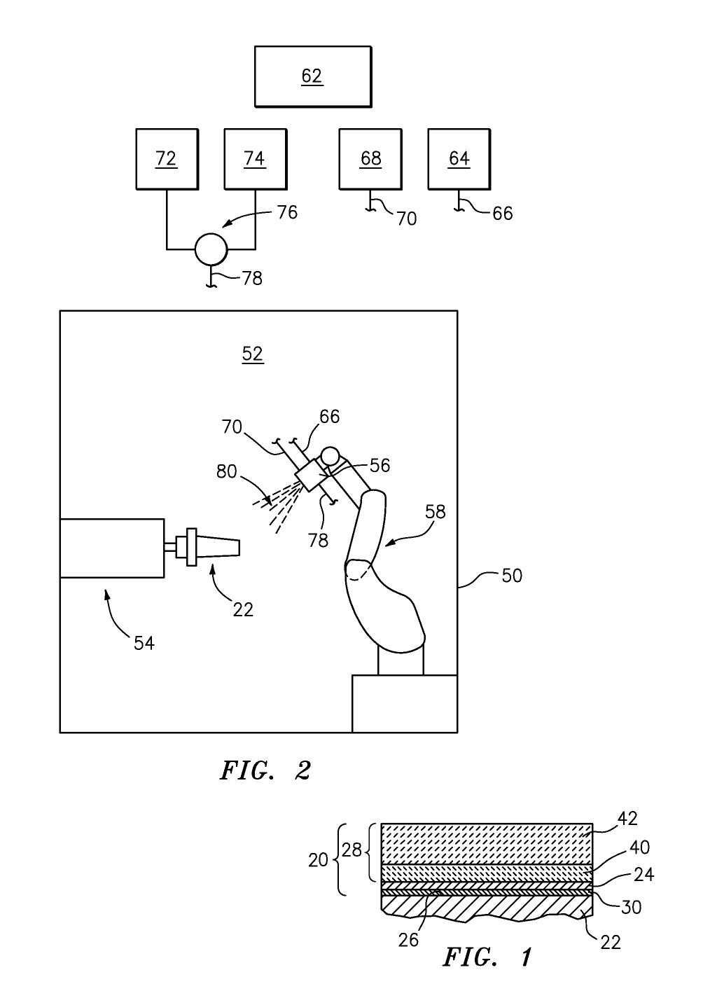

FIG. 2 is an exemplary apparatus for coating the substrate. FIG. 2 shows an exemplary chamber 50 having an interior 52 containing one or more substrates 22 held by a substrate holder 54 (which may hold the substrate(s) stationary or may move them (e.g., via rotation)). Alternative implementations may involve open-air spraying (without any chamber separate from the factory room in which spraying occurs). Exemplary spraying is at atmospheric pressure (e.g., nominally 101.3 kPa and usually at least 95 kPa). To perform the SPS process, the chamber contains an SPS gun 56. In the exemplary implementation, the gun is carried by an industrial robot 58. The gun, robot, substrate holder, and other controllable system components may be controlled via a controller 62 (e.g., a microcontroller, microcomputer, or the like) coupled to various system components and sensors and input/output devices. The controller may have a processor, memory, and/or storage containing instructions for controlling operations such as discussed below. Communication with various controlled systems, sensors, and input/output devices may be via hardwiring or wireless communications. The controlled systems may further include a gun power source 64 coupled to the gun via a line 66, a gas source 68 coupled to the gun via a line 70, and one or more coating material sources (an exemplary two: 72&74 being shown). Exemplary coating sources are coupled via a controllable valve 76 to a line 78 extending to the gun. The exemplary sources 72 and 74 respectively provide the first and second coating layers. However, other configurations are possible including separate sources coupled to separate guns. FIG. 2 further shows the spray 80 discharged from the gun.

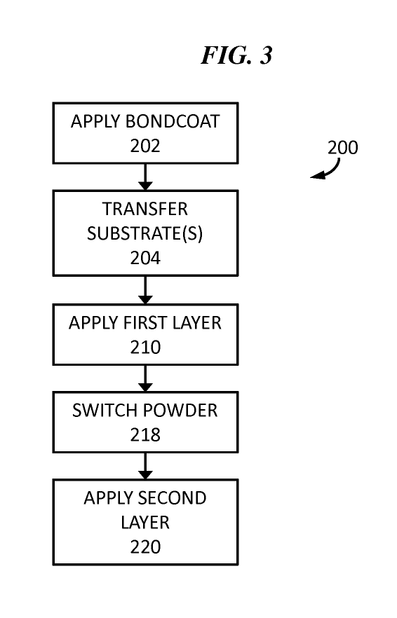

FIG. 3 shows an exemplary process 200 for coating the substrate. After initial substrate manufacture (e.g., casting, finish machining, cleaning, and the like) the bondcoat is applied 202. This may be done by LPPS (e.g., as described above). This may be performed in a first chamber (not shown) whereafter the substrate(s) are transferred 204 to a second chamber (the chamber 50 discussed above). There may also be thermal conditioning via heater (not shown).

The first layer may be applied 210 via suspension plasma spray (SPS). SPS enables a homogenous coating composition of multi-component ceramics that have varied vapor pressures because it relies on melting/softening of the ceramic and not vaporization during the transport to the substrate. In the exemplary implementation, this is performed via the first source 72. The exemplary first and second sources are liquid suspension feed systems. They store or have other supply of a suspension including a carrier such as ethanol with coating particles and dispersant. Exemplary coating particles are submicron particles in the vicinity of 300 nanometers, more broadly, 50-500 nanometers or 10-1000 nanometers at a weight concentration of 5-50% (more narrowly, 10-30 wt %). The exemplary dispersant is phosphate ester at a weight-concentration of 0.1-2%.

The gun may be formed as an otherwise conventional spray plasma source with gas comprising an exemplary argon-helium, argon-hydrogen, or argon-hydrogen-nitrogen mixture. The suspension is injected into a plasma being discharged from the gun (via internal or external feed). As the spray passes from the point of injection to the substrate, the spray fragments into droplets (e.g., having a characteristic size in the vicinity of 3 micrometers at some point). During further traversal, the carrier tends to evaporate leading to agglomeration of the particles previously within the droplet and finally followed by melting of such agglomerated clusters of particles to form respective melt droplets which impact the substrate.

After application of the first layer, the second layer is then applied 220. Exemplary application of the second layer is performed in the same chamber as the application of the first layer. In particular embodiments, it is also via SPS and, more particularly, SPS using the same spray gun as was used in applying the first layer. This may be done by simply switching 218 the powder being delivered to the gun via one or more valves such as 76 switching from the first source 72 to the second source 74.

Additional layers may be deposited (whether in the chamber 50 or otherwise). The exemplary embodiment, however, terminates coating after the second layer is applied.

Alternative methods for applying the second layer are air plasma spray (APS), high velocity oxy-fuel (HVOF), electron beam physical vapor deposition (EB-PVD including its various variants) among others.

SPS may have benefits for both first and second layers in terms of generating a columnar microstructure approaching that of EB-PVD but at lower costs. See, K. VanEvery et al., Journal of Thermal Spray Technology Volume 20(4) June 2011-817 or H. Kassner et al., Journal of Thermal Spray Technology 17 (1) 115-123 (2008) which discloses the columnar nature. Columnar microstructures are beneficial in TBCs because they provide high strain tolerance for high spallation life and continuous thermal cycling. The lower cost versus EB-PVD may result from use of an air or similar atmosphere, thereby, avoiding costs of a high vacuum system. This reduces capital costs, raw material usage, and labor costs. SPS also provides good inter-layer bonding even between relatively dissimilar materials. This enables easy formation of bi-layer or multi-layer structures.

Relative to EB-PVD, the SPS columnar microstructure may have different column structure/microstructure. The SPS coating will be polycrystalline, typically free of distinct lamellar features common in historic plasma spray coatings. The SPS coating is characterized by columns separated by vertical cracks or defined gaps (e.g., the column diameter is such that the coating is characterized by greater than 100 gaps per inch (40 gaps/cm), more narrowly >80 gaps/cm or 80-160 gaps/cm (characteristic “diameters” being the inverse thereof)). In contrast, a typical EB-PVD coating has characteristic single crystal columns with a determined crystallographic texture with individual column diameters of about 10-20 micrometers.

One or more embodiments have been described. Nevertheless, it will be understood that various modifications may be made. For example, implemented in the remanufacture of a given article for the reengineering of the configuration of such article, details of the baseline and its use may influence details of any particular implementation. Accordingly, other embodiments are within the scope of the following claims.

1. A method for coating a substrate, the method comprising:
suspension plasma spraying of a ceramic first layer, the first layer being at least about as tough as 7YSZ; and
applying a ceramic second layer over the first layer, the second layer being less tough than the first layer.

2. The method of claim 1 wherein:
the applying of the ceramic second layer is by suspension plasma spraying and both said sprayings are performed in the same chamber.

3. The method of claim 1 wherein:
during said spraying of the first layer and said applying of the second layer, an environmental pressure remains at least 95 kPa.

4. The method of claim 1 further comprising:
applying a metallic bondcoat prior to the suspension plasma spraying of the first layer.

5. The method of claim 1 wherein:
the second layer is applied directly atop the first layer.

6. The method of claim 1 wherein:
the first layer has a thickness of 0.013-0.076 mm; and
the second layer has a thickness of 0.025-0.48 mm.

7. The method of claim 1 wherein:
the first layer has a thickness of 0.013-0.076 mm;
the second layer has a thickness of 0.025-0.48 mm;
the first layer has a coefficient of thermal conductivity of 1.4-1.7 W/mK; and
the second layer has a coefficient of thermal conductivity of less than 1.1 W/mK.

8. The method of claim 1 wherein:
the first layer has a coefficient of thermal conductivity of 1.4-1.7 W/mK; and
the second layer has a coefficient of thermal conductivity of 0.4-0.9 W/mK.

9. The method of claim 1 wherein:
the suspension plasma spraying of the ceramic first layer is to a first layer depth of at least 0.013 mm; and
the applying of the ceramic second layer is to a second layer depth of at least 0.025 mm.

10. The method of claim 1, wherein:
the first layer comprises zirconia-yttria-titania.

11. The method of claim 10, wherein:
the zirconia-yttria-titania is a titania-doped 7YSZ.

12. The method of claim 1, wherein:
the first layer comprises zirconia-titania-ceria.

13. The method of claim 1, wherein:
the first layer comprises zirconia-yttria-tantala.

14. The method of claim 1, wherein:
the second layer comprises gadolinia-stabilized zirconia.

15. The method of claim 1, wherein:
the substrate comprises a nickel-based superalloy.

16. A coated article comprising:
a substrate;
a ceramic first layer having a toughness at least about as great as a toughness of 7YSZ and having a polycrystalline columnar microstructure; and
a ceramic second layer above the first layer and being less tough than the first layer.

17. The article of claim 16 wherein:
the first layer comprises material selected from the group consisting of zirconia-yttria-titania, zirconia-titania-ceria, and zirconia-yttria-tantala; and
the second layer comprises gadolinia-stabilized zirconia.

18. The article of claim 16 wherein:
the substrate comprises a nickel-based superalloy.

19. The article of claim 16 further comprising:
a bondcoat between the first layer and the substrate.

20. The article of claim 19 consisting essentially of the substrate, the bondcoat, the first layer, and the second layer.
